(19) United States
(12) Patent Application Publication
(10) Pub. No.: US 2017/0196243 A1
(43) Pub. Date: Jul. 13, 2017

(54) POTATO BASED PROTEIN MIXTURES AND NUTRITIONAL COMPOSITIONS COMPRISING POTATO PROTEIN

(71) Applicant: ABBOTT LABORATORIES, Abbott Park, IL (US)

(72) Inventors: JEFFREY BAXTER, Westerville, OH (US); RACHEL BLUMBERG, Dublin, OH (US); TIMOTHY CHAPMAN, Grove City, OH (US); NORMANELLA DEWILLE, Columbus, OH (US); KELLEY LOWE, Powell, OH (US); GAURAV PATEL, Gahanna, OH (US); DOUGLAS WEARLY, Blacklick, OH (US)

(21) Appl. No.: 15/313,738

(22) PCT Filed: Jun. 3, 2015
(86) PCT No.: PCT/US2015/033961

§ 371 Date: Nov. 23, 2016

Related U.S. Application Data
(60) Provisional application No. 62/007,036, filed on Jun. 3, 2014.

(51) Int. Cl. A23L 2/66; A23L 33/19; A23L 33/185

(52) U.S. Cl. CPC A23L 2/66; A23L 33/185; A23L 33/19; A23V 2002/00

(57) ABSTRACT

Potato protein, in combination with other vegetable proteins, replaces a portion of the total protein in a nutrition drink or shake or other nutritional composition intended for oral consumption. By suitable selection of the types and amounts of these proteins the overall cost of manufacturing the nutritional composition can be reduced without adversely affecting its other desirable properties such as nutritional value, stability, solubility, clarity, taste, and mouthfeel.

### CROSS-REFERENCE TO RELATED APPLICATIONS

This application claims priority to and any benefit of U.S. Provisional Application No. 62/007,036, filed Jun. 3, 2014, the content of which is incorporated herein by reference in its entirety.

### TECHNICAL FIELD

The general inventive concepts relate to nutritional compositions and, more particularly, to nutritional compositions that include potato protein.

### BACKGROUND

Liquid nutritional compositions typically include balanced amounts of macronutrients (proteins, carbohydrates, and fats) as well as micronutrients and flavorings. For example, nutrition drinks, i.e., non-carbonated liquid nutritional compositions which are intended for oral consumption and therefore have the consistency, flavor and overall desirable sensory characteristics of common every-day drinks or milk shakes, are widely-available consumer products. Examples include the Ensure®, Glucerna®, Myoplex®, ProSure®, and PediaSure® line of nutrition shakes available from Abbott Nutrition of Columbus, Ohio, the Muscle Milk® line of nutrition shakes available from CytoSport, Inc. of Benicia, Calif., and the Ensure® Active line of clear nutrition drinks also available from Abbott Nutrition of Columbus, Ohio. Generally, the nutrition shakes are made up in the form of oil-in-water emulsions having the consistency of common every-day milk shakes, and the clear drinks are made up in the form of a drink similar to a clear fruit-flavored juice drink. The proteins found in these liquid nutritional compositions often exhibit particularly desirable sensory-characteristic profiles. For example, dairy proteins (e.g., whey protein) are frequently used.

To reduce costs, it would be desirable to use vegetable proteins and other low cost, readily accessible proteins as part of the protein component in nutritional compositions, such as liquid nutritional compositions. Potato protein, soy protein, rice protein, wheat protein and legume protein are all examples of such alternative proteins. However, introduction of these alternative protein sources presents problems because the proteins may exhibit low aqueous solubility and are known to provide less desirable flavor and mouthfeel when substituted for dairy proteins.

Furthermore, combinations of these alternative proteins with, for example, dairy proteins have not yielded acceptable overall results for certain attributes of the nutritional compositions (e.g., sensory, quality, functionality). Accordingly, there is an unmet need for protein systems which balance the advantages of using alternative proteins against the sensory drawbacks attendant with the use of alternative proteins.

### SUMMARY

In accordance with the general inventive concepts, it has been found that the amount of vegetable protein in certain protein systems for use in nutritional compositions can be increased to levels as high as 100% based on total weight of the protein, without adversely affecting desirable properties such as nutritional value, stability, solubility, clarity, flavor, and mouthfeel. This is accomplished through the use of potato protein, and in certain embodiments, the use of potato protein in combination with non-potato proteins, including dairy protein and other vegetable proteins.

In particular, a protein ingredient which may have been considered a poor choice for use in a protein system to be included in a nutritional composition owing to deficiencies in one or more of nutritional value, stability, solubility, clarity, flavor, and mouthfeel can now be included as a protein source in such a protein system. Exemplary embodiments according to the general inventive concepts include a high branched-chain amino acid content and meet or exceed the World Health Organization (WHO) recommended guidelines for a good source of protein. Exemplary embodiments according to the general inventive concepts also meet the Protein Digestibility Corrected Amino Acid Score (PDCAAS) using essential amino acid content, digestability, and WHO recommended guidelines.

The general inventive concepts relate to potato-based protein systems and nutritional compositions that incorporate the potato-based protein systems, such as: pediatric nutritional compositions, adult medical nutritional compositions, and performance nutritional compositions. The potato-based protein system may be used in any form of liquid, spray-dried, dry-blended, and extruded powdered nutritional compositions. More specifically, the potato-based protein mixture comprises more than 10% by weight and up to 90% by weight of vegetable protein comprising a source of potato protein and a mixture of soy, rice, wheat, and legume proteins. The protein system further comprises a dairy protein selected from the group of milk derived proteins selected from milk protein isolate, milk protein concentrate, sodium caseinate, calcium caseinate, micellar casein, whey protein, whey protein isolate, hydrolyzed milk protein isolate, hydrolyzed milk protein concentrate, hydrolyzed sodium caseinate, hydrolyzed calcium caseinate, and hydrolyzed whey protein.

In a first exemplary embodiment, a protein system for use in a nutritional composition comprises vegetable protein in an amount of between 10 to 100% by weight of the total protein, and dairy protein in an amount of 0 to 90% by weight of the total protein. The vegetable protein comprises potato protein and at least one additional vegetable protein selected from the group comprising soy protein, rice protein, wheat protein, legume protein, hydrolyzed soy protein, hydrolyzed rice protein, hydrolyzed wheat protein, and hydrolyzed legume protein. The dairy protein is selected from the group comprising milk protein isolate, milk protein concentrate, sodium caseinate, calcium caseinate, micellar casein, whey protein, whey protein isolate, hydrolyzed milk protein isolate, hydrolyzed milk protein concentrate, hydrolyzed sodium caseinate, hydrolyzed calcium caseinate, and hydrolyzed whey protein.

In a second exemplary embodiment, a liquid nutritional composition comprises a protein system and a carbohydrate. The protein system comprises potato protein in an amount of 20 to 100% by weight of the total protein, and a non-potato protein in an amount of 0 to 80% by weight of the total protein. The liquid nutritional composition is substantially clear.

### DETAILED DESCRIPTION

For the purposes of this disclosure, the following terms have the following meanings unless context dictates otherwise:

“Fat” and “oil” as used herein are used interchangeably to refer to lipid materials derived or processed from vegetables or animals. These terms also include synthetic lipid materials so long as such synthetic materials are suitable for oral administration to humans. As well known, such materials are normally composed of mixtures of fatty acid triglycerides, which mixtures may also contain fatty acid diglycerides and monoglycerides and even some free fatty acids.

“Hydrolyzed protein” refers to a source of protein which has been subjected to a specific treatment whose primary purpose is to hydrolyze unhydrolyzed proteins. In this regard, it is conventional in this industry to refer to a protein source which has been subjected to a treatment whose primary purpose is to hydrolyze unhydrolyzed (or native) proteins as a source of hydrolyzed proteins, e.g., “hydrolyzed whey protein concentrate.” In contrast, when a protein source has not been subjected to such a treatment, it is conventional practice to refer to this product as a source of intact protein, or more commonly to say nothing about the hydrolysis of its protein, even though a significant amount of the protein therein may be in hydrolyzed form.

Another way of referring to the extent of hydrolyzation in hydrolyzed protein is by Degree of Hydrolysis (DH). A DH value of, for example, 30 refers to protein in which 30% of the total protein is hydrolyzed.

“Nutritional composition” refers to nutritional liquids, nutritional solids including nutritional powders which may be reconstituted to form a nutritional liquid, nutritional puddings, nutritional gels, nutritional bars, and other nutritional products all of which comprise one or more of protein, carbohydrate, and fat, and are suitable for oral consumption by a human. In certain exemplary embodiments, the nutritional composition comprises a protein system as disclosed or suggested herein.

“Nutrition shake” refers to a liquid nutritional composition that is intended for oral consumption by the ordinary consumer and hence is formulated, manufactured, packaged, and sold in the form of a viscous liquid having the pleasing flavor and the consistency of a conventional milk shake.

“Shelf stable” refers to a liquid nutritional composition that remains commercially stable after being packaged and then stored at 18-24° C. for at least 3 months.

“Total protein” and “total amount of protein” are used interchangeably in connection with the amount of protein in a protein system or a particular nutritional composition to mean all the protein in that system or composition.

“Vegetable protein” refers to a protein from a source other than animal origin, non-limiting examples of which include: potato protein, soy protein, rice protein, wheat protein, legume protein, hydrolyzed soy protein, hydrolyzed rice protein, hydrolyzed wheat protein, and hydrolyzed legume protein.

“Non-potato protein” refers to protein from a source other than potato, non-limiting examples of which include: soy protein, rice protein, wheat protein, legume protein, hydrolyzed soy protein, hydrolyzed rice protein, hydrolyzed wheat protein, hydrolyzed legume protein, and dairy protein. Non-limiting examples of dairy protein include: milk protein isolate, milk protein concentrate, sodium caseinate, calcium caseinate, micellar casein, whey protein, whey protein isolate, hydrolyzed milk protein isolate, hydrolyzed milk protein concentrate, hydrolyzed sodium caseinate, hydrolyzed calcium caseinate, and hydrolyzed whey protein.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The compositions of this disclosure may also be substantially free of any optional or selected ingredient or feature described herein. In this context, “substantially free” means that the selected nutritional composition contains less than a functional amount of the optional ingredient, typically less than 1%, including less than 0.5%, including less than 0.1%, and also including zero percent, by weight of such optional or selected ingredient.

In addition, the compositions of this disclosure may comprise, consist of, or consist essentially of the recited elements, as described herein.

It is intended that when discussing the liquid nutritional compositions disclosed herein, that the discussion may apply equally to the protein systems, and vice versa, especially when discussing the protein component of either an exemplary protein system or an exemplary nutritional composition, including an exemplary liquid nutritional composition.

Protein systems and nutritional compositions of any type are made according to certain exemplary embodiments with a significant amount of potato protein in addition to other proteins. It has been found that the total amount of vegetable protein in a nutritional composition intended for oral consumption can be increased to levels higher than previously thought without adversely affecting its nutritional value, flavor, and other desirable hedonic properties, by using particular combinations of proteins. That is to say, it has been found that the undesirable flavor off-notes and organoleptic properties that typically derive from different types of vegetable based proteins when used to replace a substantial portion of the milk proteins in a commercially viable nutritional composition intended for oral consumption can be largely eliminated, or at least reduced significantly, if a substantial portion of the vegetable protein used for this replacement is based on potato protein in combination with additional vegetable proteins. In addition, it has been found that potato protein can be used in a nutritional composition in the form of a clear beverage without undesirable clarity, flavor off-notes, or mouthfeel found when substituting other vegetable proteins for whey protein in such clear beverages. Moreover, it has also been found that potato protein can provide additional benefits including forming a non-coagulating protein in the stomach. Furthermore, proteins of vegetable origin, such as potato protein, have higher sustainability scores compared to animal origin proteins and enzymes associated with potato proteins have been linked to potential health benefits other than simple nutrition such as inhibition of proteolitic activity (a significant cause of intestinal inflammation in infants), inhibition of tumor cell growth and bolstering defense against microbial pathogens.

### Product Form

The exemplary nutritional compositions include those suitable for oral administration. Oral administration, as defined herein, includes any form of administration in which the nutritional composition passes through the esophagus of the individual. For example, oral administration includes nasogastric intubation, in which a tube is run through the nose to the stomach of the individual to administer food or drugs.

The exemplary nutritional compositions include ready-to-feed liquids, concentrated liquids, liquids derived from nutritional powders (reconstituted liquids), powders, and other solids such as nutrition bars. The liquid nutritional composition may include solutions (including clear solutions), suspensions, and emulsions. The powders that are reconstituted to produce a liquid may include any flowable or scoopable particulate solid that can be diluted with water or other aqueous liquid to form a nutritional liquid prior to use.

The exemplary nutritional compositions may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit.

### Nutritional Powders

In certain exemplary embodiments, the nutritional composition is in the form of a nutritional powder. The nutritional powder may be reconstituted by the intended user with a suitable aqueous liquid, typically water, in an amount or volume sufficient to form a nutritional liquid for immediate oral use. In this context, “immediate” use generally means within about 48 hours, more typically within about 24 hours, and most typically right after or within 20 minutes of reconstitution. Further, when reconstituted, the nutritional powder provides the desired ingredient concentrations as described hereinafter for the nutritional liquid embodiments.

The nutritional powder may include spray dried powders, dry mixed powders, agglomerated powders, combinations thereof, or powders prepared by other suitable methods.

### Nutritional Liquids

In certain exemplary embodiments, the nutritional composition is in the form of a nutritional liquid. The nutritional liquid may be formulated in a variety of forms, including emulsions such as oil-in-water, water-in-oil, or complex aqueous emulsions, although such emulsions are most typically in the form of oil-in-water emulsions having a continuous aqueous phase and a discontinuous oil phase, suspensions, or clear or substantially clear liquids.

The nutritional liquid may be and typically is shelf stable. The nutritional liquids typically contains up to 95% by weight of water, including from about 50% to 95%, also including from about 60% to about 90%, and also including from about 70% to about 85% of water by weight of the nutritional liquid.

In certain exemplary embodiments, the nutritional composition is formulated as a clear liquid (i.e., a solution) having an acidic pH. In certain exemplary embodiments, the nutritional composition is an aqueous composition and has a pH ranging from 2 to 5. In certain exemplary embodiments, the pH of the nutritional composition is 2.5 to 3.5.

### Macronutrient Balance

In certain exemplary embodiments, the nutritional composition contains protein, carbohydrate, and fat in proportions which are suitable for satisfying the nutritional needs of the consumer or patient for which they are intended. Such proportions are well known in the art, and any conventional proportion can be used

The general inventive concepts are especially useful in connection with formulating liquid nutritional compositions that are intended for oral consumption by the ordinary consumer and hence are formulated to have a pleasing flavor and the consistency of a conventional clear drink or milk shake, as well as powders and concentrates which can be combined with water to form such a liquid nutritional composition. Generally speaking, these nutrition shakes when in a ready to feed condition contain protein in an amount of from about 0.5% to about 20% by weight, carbohydrate in an amount of from about 0.5% to about 35% by weight, and fat in an amount of from about 0.1% to about 25% by weight, with the particular balance of these macronutrients depending on the specific purpose for which a particular nutritional composition is formulated.

Thus, such compositions when in a ready to use condition typically contain concentrations of these macronutrients as set forth in the following Tables 1 to 4, with the percentages shown being based on the entire weight of each composition:

TABLE 1
Macronutrient profile for nutritional composition
for muscle building formulations.
Table 1

| | % weight based on | | | | | |
|---|---|---|---|---|---|---|
| | entire composition | | | Calorie % | | |
| | Protein | Carbs | Fat | Protein | Carbs | Fat |
| Operative | 3-20 | 0.5-15 | 1-10 | 35-75 | 5-40 | 5-40 |
| Desirable | 5-15 | 1-10 | 0.3-5 | 45-70 | 10-35 | 10-35 |
| More Desirable | 6-10 | 2-6 | 0.5-2 | 40-65 | 15-30 | 15-30 |
| Especially | 6-10 | 3-5 | 0.7-1.5 | 54-58 | 21-25 | 19-23 |
| Desirable | | | | | | |

TABLE 2
Macronutrient profile for nutritional composition for adult supplement.
Table 2

| | % weight based on | | | | | |
|---|---|---|---|---|---|---|
| | entire composition | | | Calorie % | | |
| | Protein | Carbs | Fat | Protein | Carbs | Fat |
| Operative | 0.5-15 | 10-30 | 0.5-10 | 2-30 | 30-90 | 6-45 |
| Desirable | 1.4-8.5 | 11-25 | 1-7 | 6-25 | 40-80 | 10-40 |
| More Desirable | 2-7 | 13-24 | 1.5-6 | 10-20 | 45-75 | 15-35 |
| Especially Desirable | 2.9-5.8 | 14-20 | 2-5 | 12-17 | 50-70 | 20-31 |

TABLE 3
Macronutrient profile for nutritional composition for diabetics.
Table 3

| | % weight based on | | | | | |
|---|---|---|---|---|---|---|
| | entire composition | | | Calorie % | | |
| | Protein | Carbs | Fat | Protein | Carbs | Fat |
| Operative | 0.5-15 | 5-35 | 0.5-20 | 10-40 | 20-70 | 15-55 |
| Desirable | 1-10 | 7-20 | 0.7-15 | 12-35 | 30-60 | 20-45 |
| More Desirable | 2-7 | 8-15 | 1-10 | 15-30 | 35-55 | 25-40 |
| Especially Desirable | 3-5 | 9-12 | 1.5-5 | 18-25 | 40-50 | 30-35 |

TABLE 4
Macronutrient profile for nutritional composition for children.
Table 4

| | % weight based on | | | | | |
|---|---|---|---|---|---|---|
| | entire composition | | | Calorie % | | |
| | Protein | Carbs | Fat | Protein | Carbs | Fat |
| Operative | 0.5-10 | 4-40 | 1-25 | 2-40 | 30-80 | 15-55 |
| Desirable | 0.7-7 | 6-30 | 1.2-20 | 4-30 | 40-70 | 20-45 |
| More Desirable | 1-6 | 8-20 | 1.5-15 | 7-20 | 45-65 | 25-40 |
| Especially Desirable | 2-4 | 10-15 | 2-7 | 10-15 | 50-60 | 30-35 |

### Protein

In certain exemplary embodiments, the protein system comprises protein from one or more sources. Traditionally, milk proteins have been the proteins of choice for making a wide variety of different nutritional compositions. For various reasons, however, including cost, efforts have been undertaken to replace some or all of these milk proteins with vegetable proteins. However, vegetable proteins normally produce a negative effect on the desirable properties that nutritional compositions exhibit including flavor, odor, viscosity (in the case of liquids), texture, short term stability, long term (shelf) stability and nutritional value.

As indicated above, vegetable proteins generally exhibit various undesirable flavor off-notes. This is illustrated in the following Table 5, which shows the sensory flavor off-notes that certain common vegetable proteins exhibit:

TABLE 5

| Pea | Soy | Potato | Hydrolyzed Rice | Intact Rice |
|---|---|---|---|---|
| green pea | Bitter | Tannin | Cardboard/brown paper | Soy |
| Bitter | Beany | Potato/ | Starchy/rice water | cardboard |
| Green tea | | methionine | Bitter | Bitter |

Because of these off-notes, experience has shown that when the amount of vegetable protein in commercially viable nutritional compositions intended for oral consumption begins exceeding roughly 30% by weight of the total protein, undesirable flavor notes begin to appear.

In accordance with the general inventive concepts, it has been found that the amount of vegetable protein that can be included in a protein system intended for oral consumption can be increased beyond previous values, without introducing undesirable flavor notes, if a significant portion of the vegetable protein used for this purpose is composed of potato protein.

In certain exemplary embodiments, a protein system for use in a nutritional composition comprises vegetable protein or a source of vegetable protein. Both intact and hydrolyzed versions of vegetable protein can be used. The amount of vegetable protein present in the protein system can vary widely and may be based on the particular needs of the intended consumer, or the intended product form of the nutritional composition. In certain exemplary embodiments, vegetable protein is present in the protein system in an amount of 10 to 100% by weight of the total protein. In certain exemplary embodiments, vegetable protein is present in the protein system in an amount of 20 to 40% by weight of the total protein.

In certain exemplary embodiments, a protein system for use in a liquid nutritional composition comprises potato protein and at least one additional vegetable protein or a source of an additional vegetable protein. Non-limiting examples of additional vegetable proteins include: soy protein, rice protein, wheat protein, legume protein, hydrolyzed soy protein, hydrolyzed rice protein, hydrolyzed wheat protein, and hydrolyzed legume protein. In certain exemplary embodiments, the at least one additional vegetable protein is present in a protein system in an amount of 0 to 80% by weight of the total protein. In certain exemplary embodiments, the at least one additional vegetable protein is present in the protein system in an amount of 10 to 70% by weight of the total protein.

### Potato Protein

In certain exemplary embodiments, a protein system for use in a liquid nutritional composition comprise potato protein or a source of potato protein. Both intact and hydrolyzed versions of potato protein can be used. The amount of potato protein present in the protein system can vary widely and may be based on the particular needs of the intended consumer, or the intended product form of the nutritional composition. In certain exemplary embodiments, potato protein is present in the protein system in an amount of 5 to 40% by weight of the total protein. In certain exemplary embodiments, potato protein is present in a protein system in an amount of 5 to 20% by weight of the total protein. In certain exemplary embodiments, potato protein is present in the protein system in an amount of 20 to 40% by weight of the total protein. In certain exemplary embodiments, potato protein is present in the protein system in an amount of about 10% by weight of the total protein. In certain exemplary embodiments, potato protein is present in the protein system in an amount of 20 to 100% by weight of the total protein. In certain exemplary embodiments, potato protein is present in the protein system in an amount of 20 to 95% by weight of the total protein. In certain exemplary embodiments, the amount of potato protein present in the protein system is greater than the amount of whey protein present in the protein system. In certain exemplary embodiments, the protein system consists of potato protein.

Potato proteins are commercially available in the form of concentrates and isolates containing 80% to 95% protein. They are available, for example, from Solanic, which is a subsidiary of AVEBE of Veedam, The Netherlands.

Use of potato protein in the protein system is also advantageous due to its particular concentration of certain amino acids. However, as indicated previously, its use has been avoided due to organoleptic and hedonic issues associated with potato protein. Table 6 is an amino acid profile for a suitable potato protein for use in certain exemplary embodiments of the protein system.

TABLE 6

| | mg/g of |
|---|---|
| Amino Acid | protein |
| Alanine | 24.4 |
| Arginine | 49.8 |
| Aspartic Acid | 137 |
| Cysteine | 26.3 |
| Glutamic acid | 78.7 |
| Glycine | 58 |
| Histidine | 18.6 |
| Isoleucine | 55.9 |
| Leucine | 99.5 |
| Lysine | 80.5 |
| Methionine | 12.9 |
| Phenylalanine | 67.7 |
| Proline | 56.9 |
| Serine | 53 |
| Threonine | 45.8 |
| Tryptophan | 6.46 |
| Tyrosine | 56.6 |
| Valine | 81.2 |

### Dairy Protein

In certain exemplary embodiments, a protein system for use in a nutritional composition comprises dairy protein. The dairy protein may be selected from one source or more than one source. There are two basic types of dairy proteins, casein and whey. These to proteins occur naturally in milk in a weight ratio of about 20% by weight whey and 80% by weight casein. Dairy proteins are commercially available in a variety of different forms. Examples include milk protein isolates, concentrates, caseinates, whey isolates or concentrates, milk, non-fat dry milk, condensed skim milk, and micellar proteins such as micellar caseins and micellar milk protein concentrate all of which may be useful in certain exemplary embodiments.

The amount of dairy protein present in the protein system can vary widely and may be based on the particular needs of the intended consumer, or the intended product form of the nutritional composition. In certain exemplary embodiments, the protein system comprises dairy protein in an amount of 0 to 90% by weight of the total amount of protein. In certain exemplary embodiments, the protein system comprises dairy protein in an amount of 10 to 80% by weight of the total amount of protein. In certain exemplary embodiments, the protein system comprises dairy protein in an amount of 60 to 80% by weight of the total amount of protein. In certain exemplary embodiments, the protein system comprises 20 to 50% by weight of the total amount of protein as at least one of milk protein isolate, milk protein concentrate, sodium caseinate, calcium caseinate, micellar casein, whey protein, whey protein isolate, hydrolyzed milk protein isolate, hydrolyzed milk protein concentrate, hydrolyzed sodium caseinate, hydrolyzed calcium caseinate, and hydrolyzed whey protein. In certain exemplary embodiments, the protein system comprises about 40% by weight of the total amount of protein as at least one of milk protein isolate, milk protein concentrate, sodium caseinate, calcium caseinate, micellar casein, whey protein, whey protein isolate, hydrolyzed milk protein isolate, hydrolyzed milk protein concentrate, hydrolyzed sodium caseinate, hydrolyzed calcium caseinate, and hydrolyzed whey protein.

In certain exemplary embodiments, a protein system for use in a nutritional composition comprises whey protein. The whey protein may be selected from one source or more than one source. Common forms of whey protein include whey protein concentrate and whey protein isolate. Various commercial sources of whey protein exist, containing varying concentrations of protein such as about 75% by weight protein. The amount of whey protein present in the protein system can vary widely and may be based on the particular needs of the intended consumer, or the intended product form of the nutritional composition. In certain exemplary embodiments, the protein system comprises whey protein in an amount of 0 to 80% by weight of the total protein. In certain exemplary embodiments, the protein system comprises whey protein in an amount of 5 to 80% by weight of the total protein. In certain exemplary embodiments, the protein system comprises whey protein in an amount of 0 to 20% by weight of the total protein. In certain exemplary embodiments, the protein system comprises whey protein in an amount of about 10% by weight of the total protein. In certain exemplary embodiments, the protein system comprises whey protein isolate in an amount of 5 to 80% by weight of the total protein.

In certain exemplary embodiments, the protein system comprises milk protein. The milk protein may be selected from one or more sources. The term milk protein concentrate is generally used to refer to a milk protein containing product that has had a considerable amount of the inherent water from ordinary milk removed and also has had inherent fat from the ordinary milk removed. The term milk protein isolate is generally used to refer to a milk protein-containing product that has not only had a considerable amount of the inherent water and the inherent fat from ordinary milk removed but also a certain amount of the inherent lactose removed. In most instances, milk protein isolates can be considered to be a type of further purified milk protein concentrate.

As used herein, the phrase milk protein isolate should be understood to mean a source of milk protein that comprises milk that has been concentrated (i.e., by removal of water and fat) and has also had a portion of its lactose content removed. Generally, commercially available milk protein isolates contain about 85-90 weight % protein (or more), about 2-5 weight % lactose, minimal fat (e.g., 1-3%), and about 5-6 weight % water and a somewhat lower amount of lactose than milk protein concentrates. Certain manufacturers may use the term milk protein concentrate to refer to milk-based protein products even if they contain more than 85 weight % protein and such products should be considered to be within the scope of the term milk protein isolate as that term is used herein.

In certain exemplary embodiments, the protein system comprises casein. The casein may be selected from one source or more than one source. Both intact casein and hydrolyzed casein sources can be used. The amount of casein present in the protein system can vary widely and may be based on the particular needs of the intended consumer, or the intended product form of the nutritional composition. Casein separates from milk when milk is curdled, and is commonly called caseinate, having lost its typical micellar structure. Casein is most commonly bound to calcium (Ca²⁺), sodium (Na⁺), potassium (K⁺) or magnesium (Mg²⁺), since all of these ions are found naturally in milk. Nutritionally, these compounds are basically interchangeable, as all forms of casein are effective protein sources. Micellar casein refers to casein in the form of native micelles. Micellar casein is concentrated by a process that does not, or does not substantially, denature the casein proteins and it is often marketed as Micellar Casein Isolate (MCI). It can be obtained when fresh skim milk is subjected to a microfiltration process, in much the same process used to concentrate whey protein, to produce a pure, substantially undenaturated milk protein with its native structure.

In certain exemplary embodiments, the protein system comprises a hydrolyzed caseinate (e.g., hydrolyzed sodium casein or hydrolyzed calcium caseinate). When present in the disclosed embodiments, the hydrolyzed caseinate may include sodium caseinate, potassium caseinate, magnesium caseinate, calcium caseinate, and combinations thereof.

### Soy Protein

In certain exemplary embodiments, the protein system comprises soy protein. The soy protein may be selected from one or more sources. Both intact soy protein and hydrolyzed soy protein sources can be used.

Soy protein is a vegetable protein that contains most essential amino acids in a relatively high proportion. Soy protein can be divided into different categories according to its production method. For the purposes of this disclosure, “soy protein” will be understood to be a generic term referring to products which are basically soybean without the water soluble carbohydrates and which contain about 60 to about 90% by weight or more soy protein. Typically, these products contain about 60 to about 85% by weight soy protein, and even more typically about 70 to about 80% by weight soy protein. Meanwhile, “soy protein isolate” (SPI) will be understood to mean a type of soy protein which contains about 85 to about 90% by weight soy protein.

The amount of soy protein present in the protein system can vary widely and may be based on the particular needs of the intended consumer, or the intended product form of the nutritional composition. In certain exemplary embodiments, the protein system comprises soy protein in an amount of 10 to 50% by weight of the total protein. In certain exemplary embodiments, the protein system comprises soy protein in an amount of about 40% by weight of the total protein.

Several commercial sources of soy protein are readily available to the skilled person, for example, from The Solae Company of St. Louis, Mo., USA, and the Arthur Daniels Midland Company of Decatur, Ill., USA.

### Rice Protein

In certain exemplary embodiments, the protein system comprises rice protein. The rice protein may be selected from one or more sources. Both intact rice protein and hydrolyzed rice protein sources can be used. Rice proteins derived from both Asian rice (Oryza sativa) and African rice (Oryza glabemma) can be used.

The amount of rice protein present in the protein system can vary widely and may be based on the particular needs of the intended consumer, or the intended product form of the nutritional composition. Rice protein is commercially available in the form of rice protein concentrates and isolates. These products are available from a wide variety of different commercial sources including Shanghai Freemen Chemicals Company, LLC. of Shanghai, China.

### Wheat Protein

In certain exemplary embodiments, the protein system and the liquid nutritional composition comprises wheat protein. The wheat protein may be selected from one or more sources. Both intact wheat protein and hydrolyzed wheat protein sources can be used. Wheat protein is available commercially both in the form of a wheat protein concentrate and a wheat protein isolate. The amount of wheat protein present in the protein system can vary widely and may be based on the particular needs of the intended consumer, or the intended product form of the nutritional composition.

Wet-processing of wheat flour yields two important co-products: starch and gluten (protein). Wheat gluten (also known in commerce as vital wheat gluten) typically contains 75% protein (dry basis) and is classified as a wheat protein concentrate. Further processing of this gluten, either by mechanical means or solubilization in the presence of processing aids followed by centrifugation or filtration, typically yields a higher protein product (approximately 90%, dry basis) using a nitrogen conversion factor of 5.7. Due to elevated protein content, the product is classified as a wheat protein isolate. Suitable wheat protein for use according to the general inventive concepts is available commercially from the Tereos Corporation of Tour Lilleroupe, France.

### Legume Protein

In certain exemplary embodiments, the protein system comprises legume protein. The legume protein may be selected from one or more sources. While soy protein is a legume, for the purposes of this discussion, legume protein will refer to legumes other than soy, including but not limited to pea and lentil. Both intact legume protein and hydrolyzed legume protein sources can be used.

In addition to sensory characteristics such as taste, texture, and color, many vegetable proteins suffer from additional drawbacks which make it difficult or impossible, as a practical matter, to formulate nutritional compositions containing only vegetable proteins. In particular, many vegetable proteins are deficient in one or more indispensable amino acids. For example, proteins derived from corn, wheat, and rice are deficient in lysine. Accordingly, nutritional compositions made with these vegetable proteins are normally supplemented with dairy proteins or specific amino acids such as lysine and methionine to supply these missing indispensable amino acids.

As well understood in the nutrition arts, the Food and Agriculture Organization of the United Nations, which is commonly referred to as the “FAO,” has established certain requirements for the quality of the proteins in foods intended for adult consumption. In particular, the FAO has established standards for the minimum amounts of indispensible amino acids that should be present in foods intended for consumption by normal healthy adults.

In this regard, the concentrations of indispensible amino acids in the proteins derived from lentils, peas, and soybeans is given in the following Table 7 as mg per g of protein.

TABLE 7

| Indispensable | Lentil | | |
|---|---|---|---|
| amino acid | protein^{a} | Pea protein^{b} | Soy protein^{c} |
| His | 28 | 24 | 26 |
| Ile | 46 | 41 | 49 |
| Leu | 72 | 72 | 82 |
| Lys | 68 | 72 | 63 |
| Met + Cys | 29 | 25 | 26 |
| Phe + Tyr | 78 | 75 | 90 |
| Thr | 36 | 36 | 38 |
| Trp | 7 | 11 | 12 |
| Val | 50 | 47 | 51 |

^{a}Wang N and Daun J K, Food Chem, 95 (2006) 493-502
^{b}USDA Nutrient Database, entry 16085
^{c}USDA Nutrient Database, entry 16175

In certain exemplary embodiments, the legume protein is pea protein. Particularly suitable pea proteins include pea proteins derived from Pisum sativum. Pea proteins derived from other species of peas, including green peas and field peas, can also be used. The amount of legume protein present in the protein system can vary widely and may be based on the particular needs of the intended consumer, or the intended product form of the nutritional composition.

Pea protein is commercially available in the form of pea protein concentrates (PPC) and pea protein isolates (PPI). One commercially available pea protein concentrate that may be suitable for use in the nutritional compositions of this disclosure and which is based on pisum sativum is NUTRALYS® F85F pea protein isolate (about 83% by weight pea protein), available from Roquette Freres, Lestrem France. Another source for pea protein based on pisum sativum is Cosucra Groupe Warcoing of Warcoing, Belgium.

### Amino Acids

In certain exemplary embodiments, the protein system is used in a nutritional composition that also includes a high branched-chain amino acid content which meets or exceeds the World Health Organization (WHO) recommended guidelines for a good source of protein. The amount of certain amino acids present in the protein system or the nutritional composition can vary widely and may be based on the particular needs of the intended consumer, or the intended product form. In certain exemplary embodiments, the protein system comprises 30 to 50 mg of arginine per gram of total protein. In certain exemplary embodiments, the protein system comprises 40 to 70 mg of phenylalanine per gram of total protein.

Table 8 shows the amino acid breakdown of two exemplary protein systems, 1) a 95:5 combination of potato protein: whey protein, and 2) a 20:80 combination of potato protein: whey protein. For comparison purposes, values for 100% potato protein and 100% bovine whey protein are provided along with medical organization patterns (all amounts in mg/g protein).

TABLE 8

| | | | | | System 1 | System 2 |
|---|---|---|---|---|---|---|
| | FNB/IOM | FAO/WHO/UNU | | | Potato + | Potato + |
| | Pattern | Pattern Adult | | Bovine | whey | whey |
| | 2005 | 2007 | Potato | whey | (95/5) | (20/80) |
| Isoleucine\hat{ }* | 25 | 30 | 56 | 62 | 57 | 61 |
| Leucine\hat{ }* | 55 | 59 | 100 | 101 | 100 | 101 |
| Lysine* | 51 | 45 | 81 | 90 | 81 | 88 |
| Methionine*⁺ | — | — | 13 | 22 | 13 | 20 |
| Methionine*⁺ + | 25 | 22 | 39 | 44 | 40 | 43 |
| Cystine⁺ | | | | | | |
| Phenylalanine*′ | — | — | 68 | 35 | 66 | 42 |
| Phenylalanine*′ + | 47 | 38 | 124 | 67 | 121 | 78 |
| Tyrosine′ | | | | | | |
| Tryptophan*′ | 7.0 | 6.0 | 6.5 | 19 | 7.1 | 17 |
| Threonine* | 27 | 23 | 46 | 73 | 45 | 68 |
| Valine\hat{ }* | 32 | 39 | 81 | 62 | 80 | 66 |
| Histidine*′ | 18 | 15 | 19 | 20 | 19 | 20 |
| Branched chain | — | — | 237 | 225 | 237 | 227 |
| amino acids | | | | | | |
| Arginine | — | — | 50 | 27 | 49 | 31 |

\hat{ }Branched Chain Amino Acid
*Essential amino acid
⁺Sulfur amino acids
′Aromatic amino acids

As can be seen from Table 8, the combination of potato protein and whey protein creates a protein system (i.e., system 1 and system 2) that meets or exceeds the recommendations for the amino acids. Potato protein solely or with addition of whey protein to balance the amino acid profile results in an increase in arginine which may benefit the cardiovascular health of particular consumers. Additionally, potato protein is high in phenylalanine (˜200% of whey protein). Phenylalanine is reported to benefit mood, alertness, and appetite. In addition, a protein system including potato protein may also be beneficial to those on dialysis as it is lower in phosphorus, potassium, and sodium (see Table 9), which are all known to complicate dialysis.

TABLE 9

| Minerals, | 100% Whey | 100% Potato |
|---|---|---|
| mg/10 oz | protein Isolate | protein |
| Phosphorus | 218 | 2 |
| Potassium | 57 | 17 |
| Sodium | 37 | 20 |

In addition to the above proteins and amino acids, the protein systems and nutritional compositions can also contain free amino acids, if desired. Examples include L-arginine, L-cysteine, L-glutamine, L-leucine, L-proline, valine, isoleucine, and L-tryptophan. Particularly suitable free amino acids include L-arginine and L-glutamine. Desirable branched chain amino acids include leucine, isoleucine, and valine.

### Carbohydrate

In certain exemplary embodiments, the protein system is used in a nutritional composition that also includes carbohydrate or a source of carbohydrate. The amount of carbohydrate present in the nutritional composition can vary widely and may be based on the particular needs of the intended consumer, or the intended product form. Any carbohydrate or source thereof that is suitable for use in oral nutritional products and is compatible with the other ingredients of the inventive compositions can be used as the carbohydrate in the nutritional compositions. Non-limiting examples of a source of carbohydrate suitable for use in the nutritional compositions described herein include maltodextrin, hydrolyzed or modified starch or cornstarch, glucose polymers, corn syrup, corn syrup solids, rice-derived carbohydrates, sucrose, glucose, fructose, lactose, high fructose corn syrup, honey, sugar alcohols (e.g., maltitol, erythritol, sorbitol, etc.), isomaltulose, sucromalt, pullulan, potato starch, slowly-digested carbohydrates, dietary fibers including, but not limited to, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal beta-glucans (e.g., oat beta-glucan, barley beta-glucan), carrageenan and psyllium, Fibersol™, other resistant starches, and combinations thereof.

### Fat

In certain exemplary embodiments, the protein system is used in a nutritional composition that also includes fat or a source of fat. The amount of fat present in the nutritional composition can vary widely and may be based on the particular needs of the intended consumer, or the intended product form. Any fat or source thereof that is suitable for use in oral nutritional products and is compatible with the other ingredients of the inventive compositions can be used. Non-limiting examples of suitable fats or sources thereof for use in the nutritional compositions described herein include coconut oil, fractionated coconut oil, soy oil, corn oil, olive oil, safflower oil, high oleic safflower oil, MCT (medium chain triglycerides) oil, sunflower oil, high oleic sunflower oil, palm and palm kernel oils, palm olein, canola oil, marine oils, cottonseed oils, and combinations thereof. Desirably, a fat source will provide at least one long chain polyunsaturated acid (LC-PUFA) such as DHA, ARA, and/or EPA, although these LC-PUFAs may be optionally added to the nutritional compositions outside of, or in addition to, the other sources of fat.

In certain exemplary embodiments, the nutritional composition is desired to be clear, or at least substantially translucent, and is substantially free of fat. As used herein “substantially free of fat” refers to a nutritional composition containing less than 0.5%, including less than 0.1%, fat by weight of the total composition. “Substantially free of fat” also may refer to a nutritional composition disclosed herein that contains no fat, i.e., zero fat. In those embodiments of the nutritional composition that are substantially free of fat but have some amount of fat present, the fat may be present as a result of being inherently present in another ingredient, or the fat may be present as a result of being added as one or more separate sources of fat. In certain exemplary embodiments, the term substantially free of fat refers to a nutritional composition wherein there is no caloric lipid component (i.e., less than a functional amount of the ingredient, typically less than 0.5% by weight, and also including zero percent by weight, of such ingredient) in the nutritional composition. In certain exemplary embodiments, a nutritional composition that includes a lipid that is introduced as a component of one or more ingredients but does not contribute substantially to the caloric value of the nutritional composition is considered to be substantially free of fat. In certain exemplary embodiments, a nutritional composition that includes emulsifiers, phospholipids, or the like, in amounts that do not contribute substantially to the caloric value of the nutritional composition, is considered to be substantially free of fat.

### Optional Ingredients

In certain exemplary embodiments, the nutritional composition including the protein system may further comprise other optional ingredients that may modify its physical, chemical, hedonic, or processing characteristics or serve as pharmaceutical or additional nutritional components when used in the targeted population. Many such optional ingredients are known or otherwise suitable for use in other nutritional compositions and may also be used in the nutritional compositions described herein, provided that such optional ingredients are safe and effective for oral administration and are compatible with the essential and other ingredients in the selected product form.

Different sources and types of proteins, carbohydrates, lipids, vitamins, and minerals, are known and may be used in the exemplary embodiments herein, provided that such nutrients are compatible with the added ingredients in the selected formula, are safe for their intended use, and do not otherwise unduly impair product performance.

In certain exemplary embodiments, the nutritional composition further comprises any of a variety of vitamins or related nutrients, non-limiting examples of which include vitamin A, vitamin D, vitamin E, vitamin K, thiamine, riboflavin, vitamin B6, vitamin B12, carotenoids, niacin, folic acid, pantothenic acid, biotin, vitamin C, choline, inositol, salts, and derivatives thereof, and combinations thereof

In certain exemplary embodiments, the nutritional composition further comprises any of a variety of minerals, non-limiting examples of which include phosphorus, magnesium, calcium, iron, zinc, manganese, copper, sodium, potassium, molybdenum, chromium, selenium, chloride, iodide, and combinations thereof

In certain exemplary embodiments, the nutritional composition may be an excellent source of (as defined by the Food and Drug Administration) at least one of the following: calcium, iron, riboflavin, vitamin B6, folate, pantothenic acid, phosphorous, iodine, zinc, selenium, manganese, copper, chromium, molybdenum, and combinations thereof

In certain exemplary embodiments, the nutritional composition may be a good source of (as defined by the Food and Drug Administration) at least one of the following: vitamin A, vitamin C, vitamin E, thiamin, niacin, biotin, and combinations thereof

Non-limiting examples of other optional ingredients include fiber, preservatives, additional antioxidants, emulsifying agents, buffers, colorants, flavors, probiotics, prebiotics, thickening agents and stabilizers, and so forth.

In certain exemplary embodiments, the nutritional composition comprises fiber or a source of fiber. The fiber may be provided by one source or multiple sources of fiber. The particular amount of fiber present in the nutritional composition may vary depending upon the nutritional needs of the intended user. Fiber is defined as the indigestible portion of food consumed by animals. Dietary fiber is often categorized into soluble and insoluble fiber sources. Non-limiting examples of fibers and sources thereof which may be suitable for use in the exemplary embodiments include: insoluble fibers such as raffinose and lignin; and soluble fibers such as inulin, fructooligosaccharides (FOS), galactooligosaccharides (GOS), beta-glucans, xylose, and polydextrose.

In certain exemplary embodiments, the nutritional composition comprises at least one sweetening agent. In certain exemplary embodiments, the at least one sweetening agent is at least one sugar alcohol such as maltitol, erythritol, sorbitol, xylitol, mannitol, isolmalt, and lactitol, or at least one artificial or high potency sweetener such as acesulfame K, aspartame, sucralose, saccharin, stevia, tagatose, and combinations thereof. The sweetening agents, especially as a combination of a sugar alcohol and an artificial sweetener, may be especially useful in formulating nutritional compositions having a desirable flavor profile. These sweetener combinations can effectively mask undesirable flavors, for example, as sometimes associated with the addition of vegetable proteins to a nutritional composition. In certain exemplary embodiments, the nutritional composition may comprise at least one sugar alcohol with a concentration of from at least 0.01%, including from about 0.1% to about 10%, and also including from about 1% to about 6%, by weight of the nutritional composition. In certain exemplary embodiments, the nutritional composition may comprise at least one artificial sweetener with a concentration in a range from 0.01% to 5%, including from 0.05% to 3%, and also including from 0.1% to 1%, by weight of the nutritional composition.

In certain exemplary embodiments, the nutritional composition comprises a stabilizer. Any stabilizer that is known or otherwise suitable for use in a nutritional composition may be suitable for use herein, some non-limiting examples of which include gums such as carrageenan and xanthan gum. In certain exemplary embodiments, the stabilizer may represent from about 0.1% to about 5%, including from about 0.5% to about 3%, and including from about 0.7% to about 1.5%, by weight of the nutritional composition.

In certain exemplary embodiments, the nutritional composition comprises one or more masking agents to reduce or otherwise obscure the effects of any bitter flavors and after taste that may develop in the nutritional composition over time. Suitable masking agents include natural and artificial sweeteners; sodium sources such as sodium chloride; and combinations thereof. The amount of masking agent added to the nutritional composition may vary depending upon the particular masking agent selected, other ingredients in the formulation, and other formulation or product target variables. Such amounts, however, can range from 0.1% to 3%, including from about 0.15% to about 3%, and also including from about 0.2% to about 2.5%, by weight of the nutritional composition.

The various exemplary embodiments of the nutritional composition disclosed herein, as well as other embodiments contemplated by the general inventive concepts, may be prepared by any process or suitable method (now known or known in the future) for making a selected product form, such as a nutritional liquid, a nutritional solid, or a nutritional powder. Many such techniques are known for any given product form and can easily be applied by one of ordinary skill in the art to the various embodiments presented herein.

### Methods of Manufacture

In certain exemplary embodiments, the protein system and the nutritional compositions including same may be manufactured by any known or otherwise suitable method. Inventive nutritional compositions in liquid form may be suitably sterilized either by aseptic sterilization or by retort sterilization.

In those embodiments in which the nutritional compositions are in the form of a nutrition shake, they may be prepared by any of the well known methods of formulating such compositions by way of retort, aseptic packaging, or hot fill processing methods.

For example, in one suitable manufacturing process for formulating a nutrition shake, at least three separate slurries are prepared, including a protein-in-fat (PIF) slurry, a carbohydrate-mineral (CHO-MN) slurry, and a protein-in-water (PIW) slurry. The PIF slurry is formed by heating and mixing the oil (e.g., canola oil, corn oil) and then adding an emulsifier (e.g., lecithin), fat soluble vitamins, and a portion of the total protein (e.g., intact pea protein concentrate, milk protein concentrate) with continued heat and agitation. The CHO-MIN slurry is formed by adding with heated agitation to water: minerals (e.g., potassium citrate, dipotassium phosphate, sodium citrate), trace and ultra trace minerals (TM/UTM premix), thickening or suspending agent. The resulting CHO-MIN slurry is held for 10 minutes with continued heat and agitation before adding additional minerals (e.g., potassium chloride, magnesium carbonate, potassium iodide), and/or carbohydrates (e.g., HMOs, fructooligosaccharide, sucrose, corn syrup). The PIW slurry is then formed by mixing with heat and agitation the remaining protein, if any.

The resulting slurries are then blended together with heated agitation and the pH adjusted to 6.6-7.0, after which the composition is subjected to ultra high temperature (UHT) processing during which the composition is heat treated, emulsified and homogenized, and then allowed to cool. Water soluble vitamins and ascorbic acid are added, the pH is adjusted to the desired range if necessary, flavors are added, and water is added to achieve the desired total solid level. The composition is then aseptically packaged to form an aseptically packaged nutritional emulsion.

### EXAMPLES

The following examples further describe and demonstrate specific embodiments within the scope of the general inventive concepts. The examples are given solely for the purpose of illustration and are not to be construed as limitations of the present invention, as many variations thereof are possible without departing from the spirit and scope of the invention. All exemplified amounts are weight percentages based upon the total weight of the composition, unless otherwise specified.

Example 1 illustrates an exemplary embodiment of a nutritional composition in the form of a nutritional shake intended for children comprising an exemplary protein system. All ingredient amounts are listed as total amount included in a 1000 kg total batch.

Example 1

| Ingredient | kg/1,000 kg |
|---|---|
| Ingredient Water | Q.S. |
| Sucrose | 73.2 |
| Maltrin M040 | 54.7 |
| High Oleic Safflower Oil (HOSO) | 22.7 |
| Milk Protein Concentrate | 16.2 |
| Canola Oil | 12.2 |
| Potato protein | 9.89 |
| Fructooligosaccharides | 4.60 |
| Whey Protein Concentrate | 3.82 |
| Soy Protein Isolate | 3.37 |
| Avicel CL611 | 3.00 |
| Flavoring | 2.20 |
| Magnesium Phosphate | 1.42 |
| Potassium Chloride | 1.41 |
| Micronized Tricalcium Phosphate | 1.12 |
| Calcium Carbonate | 0.847 |
| Potassium Citrate | 0.722 |
| DHA Fish oil | 0.639 |
| Potassium Phosphate Monobasic | 0.605 |
| Edgar Weber Caramel | 0.500 |
| Vitamin Mineral Taurine premix | 0.417 |
| Choline Chloride | 0.397 |
| Ascorbic Acid | 0.386 |
| Soy Lecithin | 0.375 |
| Myverol (Distilled Monoglyceride) | 0.375 |
| 45% Potassium Hydroxide | 0.267 |
| Potassium Phosphate Dibasic | 0.176 |
| Sodium Chloride | 0.119 |
| Viscarin SA-359 | 0.100 |
| DEK Premix | 0.0630 |
| Lutein Powder (10%) | 0.0340 |
| Potassium Citrate | 0.0271 |
| L-Carnitine | 0.0206 |
| Vitamin A Palmitate | 0.00397 |
| Potassium Iodide | 0.000123 |

Example 2 illustrates an exemplary embodiment of a nutritional composition in the form of a (reconstitutable) nutritional powder intended for children comprising an exemplary protein system. All ingredient amounts are listed as total amount included in a 1000 kg total batch. Even with a significant portion of the total protein contributed from potato protein, the sensory, physical stability, and powder physical characteristics (wettability, dispersibility) were similar to current commercial powders.

Example 2

| Ingredient | kg/1,000 kg |
|---|---|
| Sucrose | 307 |
| Corn Syrup DE 25-33 | 254 |
| High Oleic Sunflower Oil | 135 |
| Sodium Caseinate | 95.2 |
| Soy Oil | 71.4 |
| Potato protein | 53.3 |
| MCT Oil | 39.4 |
| Whey Protein Concentrate | 24.5 |
| Oligofructose | 20.2 |
| Tricalcium phosphate | 13.7 |
| Potassium Citrate | 12.4 |
| Magnesium Chloride | 8.05 |
| Art. Vanilla | 6.80 |
| Potassium Chloride | 4.11 |
| Sodium Citrate | 1.90 |
| Choline Chloride | 1.90 |
| Ascorbic Acid | 1.10 |
| UTM/TM Premix (FSMP) | 1.10 |
| Vitamin Premix (FSMP) | 1.00 |
| 45% Potassium Hydroxide | 0.726 |
| Potassium phosphate dibasic | 0.505 |
| Lactobacillus acidophilus | 0.500 |
| m-Inositol | 0.429 |
| Taurine | 0.406 |
| Bifidobacterium infantis | 0.335 |
| Vitamin ADEK premix - India | 0.330 |
| Ascorbyl Palmitate | 0.192 |
| Ferrous sulfate | 0.146 |
| dl-Alpha Tocopheryl Acetate, USP | 0.100 |
| L-Carnitine | 0.0912 |
| Zinc Sulfate | 0.0339 |
| 30% Beta Carotene | 0.00960 |
| Manganese Sulfate | 0.00880 |
| Potassium Iodide | 0.000590 |

Examples 3 and 4 illustrate two exemplary embodiments of a nutritional composition in the form of a clear liquid nutritional composition having an acidic pH and comprising an exemplary protein system (either 95:5 potato:whey or 20:80 potato:whey). All ingredient amounts are listed in kg as total amount included in 1000 kg total batch.

| | Example 3 | Example 4 |
|---|---|---|
| | Potato + whey | Potato + whey |
| Ingredient | (95/5) | (20/80) |
| Ingredient Water | Q.S. | Q.S. |
| Maltodextrin (Maltrin M200) | 63.7 | 61.6 |
| Sucrose | 52.6 | 50.9 |
| Potato protein | 29.7 | 6.3 |
| Citric acid | 2.01 | 2.01 |
| Whey protein isolate | 1.77 | 28.4 |
| Flavor | 1.44 | 1.44 |
| Flavor | 1.20 | 1.20 |
| Ascorbic acid | 0.535 | 0.535 |
| Liquid sucralose - 25% | 0.275 | 0.275 |
| UTM/TM premix | 0.230 | 0.230 |
| Water dispersible ADEK premix | 0.178 | 0.178 |
| Acesulfame potassium | 0.110 | 0.110 |
| FD&C Red #40 | 0.0750 | 0.0750 |
| WSV Premix | 0.0379 | 0.0379 |
| Folic acid | 0.00130 | 0.00130 |
| Potassium iodide | 0.000204 | 0.000204 |

Examples 5-8 illustrate four exemplary embodiments of a nutritional composition in the form of a clear liquid nutritional composition having an acidic pH and comprising an exemplary protein system. All ingredient amounts are listed as total amount included to provide 100 lb of nutritional composition.

| Ingredient | Example 5 | | Example 6 | | Example 7 | | Example 8 | |
|---|---|---|---|---|---|---|---|---|
| Water | 84.6 | lb | 84.6 | lb | 84.6 | lb | 84.6 | lb |
| Mineral premix | 10.43 | g | 10.43 | g | 10.43 | g | 10.43 | g |
| Antifoam | 2.72 | g | 2.72 | g | 2.72 | g | 2.72 | g |
| Sucrose | 5.2 | lb | 5.2 | lb | 5.2 | lb | 5.2 | lb |
| Maltrin | 6.2 | lb | 6.2 | lb | 6.3 | lb | 6.3 | lb |
| Whey protein isolate | 1.77 | lb | 1.77 | lb | 0 | | 0 | |
| Potato protein 1 | 1.56 | lb | 0 | | 3.13 | lb | 0 | |
| Potato protein 2 | 0 | | 1.62 | lb | 0 | | 3.25 | lb |
| Flavor | 123 | g | 123 | g | 123 | g | 123 | g |
| Liquid sucralose | 12.47 | g | 12.47 | g | 12.47 | g | 12.47 | g |
| Acesulfame potassium | 4.99 | g | 4.99 | g | 4.99 | g | 4.99 | g |
| Vitamin premix | 1.72 | g | 1.72 | g | 1.72 | g | 1.72 | g |
| ADEK premix | 8.09 | g | 8.09 | g | 8.09 | g | 8.09 | g |
| Ascorbic acid | 24.27 | g | 24.27 | g | 24.27 | g | 24.27 | g |

In accordance with the general inventive concepts, a significant portion of the protein found in existing protein systems and nutritional compositions that already exhibit a favorable combination of hedonic and other properties is replaced with potato protein in a manner which (1) preserves these desirable properties, and (2) enables the total amount of vegetable proteins in the composition to be increased up to or near 100% by weight of the total protein.

In contrast to certain exemplary embodiments, vegan nutrition shakes represent a different class of composition as the exemplary embodiments still may contain a significant amount of milk protein. In this regard, it is well known in the industry that the flavor of nutritional compositions in which 100% of the protein content is vegetable based is poor in relation to the flavor of nutritional compositions containing a significant amount of milk proteins. Moreover, it is also well known in the industry that there is a limit to the amount (proportion) of milk proteins that can be replaced by vegetable proteins in milk protein based nutritional compositions without compromising their commercially desirable features such as stability, taste, and mouthfeel. In accordance with the general inventive concepts, it has been found surprisingly possible to increase the total amount of vegetable protein that can be introduced into such milk protein based nutrition compositions, without adversely affecting their stability, taste, or mouthfeel, by suitable selection of the types and amounts of vegetable proteins used for this purpose.

In accordance with the general inventive concepts, this advantageous result is accomplished by formulating the protein content of the inventive nutrition shakes to contain potato protein in an amount of 5 to 40% by weight of the total protein and at least one additional protein in an amount of 10 to 70% by weight of the total protein, with dairy protein making up the remaining protein.

Particular non-limiting examples of protein combinations according to certain exemplary embodiments include: a nutritional composition wherein the protein comprises 20-50 weight % of casein; 20-40 weight % of potato proteins; 10-40 weight % of soy proteins; 10-20% of whey proteins, as well as a nutritional composition wherein the protein comprises 50 weight % casein; 20 weight % of potato protein; 20 weight % soy protein; and 10 weight % whey protein.

Although only a few exemplary embodiments have been described above, it should be appreciated that many other embodiments exist including those derived from modifications made to the disclosed embodiments, and all such embodiments fall within the spirit and scope of the invention.

1. A protein system for use in a nutritional composition, the protein system comprising:
vegetable protein in an amount of 10 to 100% by weight of the total protein, the vegetable protein comprising potato protein and at least one additional vegetable protein selected from the group comprising soy protein, rice protein, wheat protein, legume protein, hydrolyzed soy protein, hydrolyzed rice protein, hydrolyzed wheat protein, and hydrolyzed legume protein;
dairy protein in an amount of 0 to 90% by weight of the total amount of protein, the dairy protein selected from the group comprising milk protein isolate, milk protein concentrate, sodium caseinate, calcium caseinate, micellar casein, whey protein, hydrolyzed milk protein isolate, hydrolyzed milk protein concentrate, hydrolyzed sodium caseinate, hydrolyzed calcium caseinate, and hydrolyzed whey protein.

2. The protein system of claim 1, wherein the vegetable protein comprises 20 to 40% by weight of the total protein.

3. The protein system of claim 1 wherein the dairy protein comprises 10 to 80% by weight of the total protein.

4. The protein system of claim 1 wherein the dairy protein comprises 60 to 80% by weight of the total protein.

5. The protein system claim 1 wherein the potato protein comprises 5 to 20% by weight of the total protein.

6. The protein system of claim 1 wherein the at least one additional vegetable protein comprises 10 to 70% by weight of the total protein.

7. The protein system of claim 1 wherein 20 to 50% by weight of the total amount protein is comprised of at least one of milk protein isolate, milk protein concentrate, sodium caseinate, calcium caseinate, micellar casein, whey protein, hydrolyzed milk protein isolate, hydrolyzed milk protein concentrate, hydrolyzed sodium caseinate, hydrolyzed calcium caseinate, and hydrolyzed whey protein.

8. The protein system of claim 1 wherein 20 to 40% by weight of the total amount of protein is potato protein.

9. The protein system of claim 1 wherein 10 to 50% by weight of the total amount of protein is soy protein.

10. The protein system of claim 1 wherein 0 to 20% by weight of the total amount of protein is whey protein.

11. The protein system of claim 1 comprising:
about 40% by weight of the total amount of protein selected from milk protein isolate, milk protein concentrate, sodium caseinate, calcium caseinate, micellar casein, hydrolyzed milk protein isolate, hydrolyzed milk protein concentrate, hydrolyzed sodium caseinate, hydrolyzed calcium caseinate,
about 10% by weight whey protein,
about 40% by weight soy protein, and
about 10% by weight potato protein.

12. A nutritional composition comprising the protein system of claim 1.

13. The nutritional composition of claim 12, further comprising at least one of carbohydrate and fat.

14. The nutritional composition of claim 12, wherein the nutritional composition is a solid nutritional composition.

15. The solid nutritional composition of claim 14, wherein the solid nutritional composition is a reconstitutable powder.

16. The nutritional composition of claim 12, wherein the nutritional composition is a liquid nutritional composition.

17. A liquid nutritional composition comprising:
carbohydrate, and
a protein system, wherein the protein system comprises potato protein in an amount of 20 to 100% by weight of the total protein, and a non-potato protein in an amount of 0 to 80% by weight of the total protein, and
wherein the liquid nutritional composition is substantially clear.

18. The liquid nutritional composition of claim 17, wherein the liquid nutritional composition is substantially free of fat.

19. The liquid nutritional composition of claim 17, wherein the protein system comprises from 30 to 50 mg of arginine per gram of total protein.

20. The liquid nutritional composition of claim 17, wherein the protein system comprises from 40 to 70 mg of phenylalanine per gram of total protein.

21. The liquid nutritional composition of claim 17, wherein the nutritional composition has an acidic pH.

22. The liquid nutritional composition of claim 17, wherein the nutritional composition has a pH of 2 to 5.

23. The liquid nutritional composition of claim 17, wherein the nutritional composition has a pH of 2.5 to 3.5.

24. The liquid nutritional composition of claim 17, wherein the non-potato protein is whey protein.

25. The liquid nutritional composition of claim 17, wherein the non-potato protein is whey protein isolate, soy protein isolate, wheat protein hydrolysate, and combinations thereof.

26. The liquid nutritional composition of claim 17, wherein the protein system comprises potato protein in an amount of 20 to 95% by weight of the total protein, and whey protein in an amount of 5 to 80% by weight of the total protein.

27. The nutritional composition of claim 24, wherein the amount of potato protein in the protein system is greater than the amount of whey protein in the protein system.

28. The liquid nutritional composition of claim 17, wherein the protein system consists of potato protein.

29. A protein system as defined in claim 1 for use in the treatment of the human or animal body by therapy.

30. A composition as defined in claim 12 for use in the treatment of the human or animal body by therapy.
